(19) United States
(12) Patent Application Publication
(10) Pub. No.: US 2024/0059601 A1
(43) Pub. Date: Feb. 22, 2024

(54) INTERLEAVANT PARTICLES FOR LOCATION BETWEEN STACKED GLASS SHEETS

(71) Applicant: MITSUBISHI CHEMICAL UK LIMITED, Billingham, Durham (GB)

(72) Inventors: Philip Andrew STENSON, Newton Aycliffe, Durham (GB); Michael Stephen CHISHOLM, Newton Aycliffe, Durham (GB)

(21) Appl. No.: 18/270,985

(22) PCT Filed: Dec. 22, 2021
(86) PCT No.: PCT/GB2021/053401

§ 371 Date: Jul. 5, 2023

(30) Foreign Application Priority Data
Jan. 7, 2021 (GB) 2100201.9

(51) Int. Cl. C03B 40/00; C03C 17/32; B05D 1/04; B05D 1/12

(52) U.S. Cl. CPC C03B 40/00; C03C 17/32; B05D 1/04; B05D 1/12

(57) ABSTRACT

There is described interleavant particles for location between adjacent stacked glass sheets, the interleavant particles comprising an inorganic core with an outer coating, the outer coating comprising a biodegradable and/or water soluble polymer or film forming material, wherein the inorganic core is solid up to at least 100° C. has a compressive strength of at least 3 MPa and has a volumetric mass density less than 7.5 g/cm³ at 25° C.

### TECHNICAL FIELD

The present invention relates to interleavant particles for location between adjacent stacked usually glass sheets especially during manufacture, storage and transport and to interleavant compositions comprising such particles.

### BACKGROUND

Glass interleavants provide spacing between stacked glass sheets and thereby help to prevent abrasive contact, capillary adhesion and corrosion by alkalis between adjacent glass sheets.

Commonly used glass interleavants generally comprise non-biodegradable microplastics, such as LDPE (Low Density Polyethylene) and PMMA (Poly(methyl methacrylate)). In particular, the use of PMMA has a number of benefits over other types of glass interleavants, such as affordability, adhesion of interleavant powder to glass, and ease of removal with water. A key characteristic of PMMA interleavants is the acceptance of electrostatic charge which provides the advantageous adhesion. In addition, PMMA may be produced by suspension polymerisation where the final polymer particle is already of the suitable size for direct use as a glass interleavant—approximately 50-150 μm.

However, non-biodegradable microplastics are known to accumulate in the environment and may harm aquatic organisms and animals.

In January 2019, the European Commission proposed wide-ranging restrictions on the international use of microplastics in products placed on the EU/EEA market to avoid or reduce their release into the environment. The proposal aims at reducing the amount of microplastics emitted into the environment by at least 70% and thereby prevent the release of 500,000 tonnes of microplastics over the twenty-year period following its introduction.

Natural biodegradable materials such as paper, wood flour, natural fabrics, coconut husk flour, and starch have also been used as glass interleavants. These natural materials do not match the performance associated with non-biodegradable glass interleavants. In particular, these natural materials are less effective, particularly when wet, which may be problematic in humid or wet environments. Further disadvantages of natural biodegradable glass interleavants may include staining of the glass sheets, abrasive activity on the glass sheets, compressibility, hydrophilicity (which may lead to capillary uptake of water and subsequent undesirable sticking together of glass sheets) and an inability of interleavant powder to remain adhered to the glass sheets.

Biodegradable polymers such as poly(lactic acid) (PLA) and poly(butylene succinate) (PBS) are generally produced by polycondensation reaction in a solvent system or via fermentation. The product polymer mass after solvent removal is usually extruded in the form of pellets. Glass interleavants generally have a particle size in the range 50-150 μm. Milling such pellets to obtain a suitable particle size leads to poor particle size distribution and high angularity in the particles making them unsuitable as interleavants.

Accordingly, there is a need to provide alternative glass interleavants that are: biodegradable or partially biodegradable, environmentally sustainable, match or substantially match the performance and ease of production of current non-biodegradable glass interleavants such as PMMA and/or release little or no microplastics into the environment.

### SUMMARY OF INVENTION

According to a first aspect of the invention there is provided interleavant particles for location between adjacent stacked glass sheets as claimed.

According to a second aspect of the invention there is provided a method of providing a stack of spaced glass sheets as claimed.

According to a third aspect of the invention there is provided the use of interleavant particles as claimed.

According to a fourth aspect of the invention there is provided a stack of glass sheets as claimed.

According to a fifth aspect there is provided interleavant compositions as claimed.

### DETAILED DESCRIPTION OF THE INVENTION

Advantageously, with the present invention it has been found that providing interleavant particles with an inorganic core and an outer coating formed of biodegradable and/or water soluble polymer or film forming material can solve or mitigate many of the problems associated with synthetic non-biodegradable based glass interleavants and natural biodegradable interleavants. In particular, the outer coating comprises a biodegradable and/or water soluble polymer or film forming material which degrades naturally or dissolves to thereby release little or no microplastics into the environment. For the avoidance of doubt the polymer or film forming material is generally the binder for the outer coating due to its film forming properties. Also, for the avoidance of doubt, the skilled person will appreciate that the polymer itself may or may not be film forming whereas the film forming material may include non-polymeric materials that film form. For example, the term polymer may include many film forming polymers but also cellulose which may not be film forming. On the other hand, film forming materials may include rosin which may not be polymeric. The outer coating also does not abrade the glass sheets and is usually able to accumulate sufficient electrostatic charge such that good adhesion to glass sheets is exhibited. Alternatively, the material of the outer coating may itself be sufficiently tacky i.e. so as to adhere to glass in normal use of the interleavants. It will be appreciated that the outer coating is typically in the form of a film of the polymer or film forming material. The film may also be formed from a powder coating of the polymer or film forming material. Typically, the biodegradable and/or water soluble material is film forming and may optionally be a polymer or a rosin. Furthermore, the inorganic core provides structural rigidity to the interleavant particles so that the interleavant particles have a sufficient compression strength to withstand the load applied by the glass sheets when stacked.

In the present invention, the outer coating is typically in contact with the inorganic core i.e. without an intermediate layer. The outer coating is typically not grafted or otherwise chemically bonded to the core by covalent or ionic bonds. The outer coating itself is typically not crosslinked.

A still further advantage is that by choosing a core that is itself glass or closely related to glass, the film forming material can both adhere as a coating to the glass and have residual adherence to the glass sheets in use.

Having the inorganic core solid up to at least up to at least 100° C. allows the cores to maintain their structural rigidity in use, and accordingly they do not deform or melt onto the glass, when exposed to high glass surface temperatures. For example, when exposed to high glass surface temperatures associated with the manufacture of the glass sheets, in particular following cutting of the glass sheets in the final stage of manufacture of the float glass method.

The term biodegradable herein may be taken as referring to material susceptible to degradation by biological activity. Herein biodegradable may be defined as ≥90% degradation within 24 months relative to a microcrystalline cellulose powder control sample. Degradation is measured as per methodology outlined in ISO 17556:2019 wherein it is quantified as carbon dioxide evolution from a sample of test material in a natural soil environment (using an inoculum that has not been pre-adapted) expressed as % carbon dioxide evolution relative to the theoretical maximum carbon dioxide evolution.

The biodegradable and/or water soluble polymer or film forming material for the outer coating may also be environmentally sustainable. The term environmentally sustainable used throughout the description is taken to mean the use of natural resources in such a way that does not lead to long term damage of the environment including the biosphere.

The outer coating may be more compressible than the inorganic core. The outer coating may be more compressible than the inorganic core up to at least a temperature of 100° C. The inorganic core may be incompressible or substantially incompressible in use, when located between glass sheets, i.e. when force is applied via the glass sheets, typically a stack of glass sheet.

Advantageously, having an incompressible or substantially incompressible inorganic core and a compressible outer coating also allows for an increased number of glass sheets to be stacked in a single stack.

Optionally, the biodegradable and/or water soluble polymer or film forming material for the outer coating is hydrophobic. This helps to prevent or mitigate water retention on the surface of the glass sheets when in use, which may lead to staining of the glass during high temperatures or humid conditions. This may also prevent water from migrating to the core. Alternatively, a hydrophobic layer may be applied to the outer coating.

Typically, the outer coating adheres to the glass sheet surfaces under the influence of intrinsic tackiness and/or electrostatic charge when in use. Generally, where necessary, sufficient electrostatic charge is imparted by the applicators used for interleavants which charge the interleavant particles as they are sprayed on to the glass sheets. This helps to prevent the interleavant particles rolling or slipping off the glass sheet and becoming denuded in use.

The biodegradable and/or water soluble polymer or film forming material may cover at least a part of the surface of the inorganic core. Partially covering the surface of the inorganic core with the biodegradable and/or water soluble polymer or film forming material prevents or helps to mitigate abrasive contact between the core and the glass sheets. For example, the biodegradable and/or water soluble polymer or film forming material helps to prevent the core from scratching the glass sheets.

Typically, the biodegradable and/or water soluble polymer or film forming material is contiguous with the inorganic core so as to cover the entire surface of the core. Typically, the biodegradable and/or water soluble polymer or film forming material envelopes the inorganic core. Covering the entire surface of the inorganic core with the biodegradable and/or water soluble polymer or film forming material prevents abrasive contact between the core and the glass sheets. For example, the biodegradable and/or water soluble polymer or film forming material prevents the core from scratching the glass sheets.

Typically, the outer coating is arranged such that the inorganic core substantially does not contact the glass sheets in use.

The outer coating effectively cushions the glass sheet from the core in use. This prevents abrasion of the glass sheet surface by the core.

However, it is also possible to have less than 100% surface coating coverage of the inorganic core and optionally for some of the core to also contact the glass sheets in use. The inorganic core may have a surface coating coverage of >10% such as >20, 30, 40, 50 or 60% by the outer coating, typically >70%, more typically ≥80%, even more typically ≥90%. The inorganic core may have a coating coverage of 100% by the outer coating.

The outer coating may be arranged to be in contact with the inorganic core, typically, by direct coating of the core i.e. without an intervening layer.

Although multiple coats of the outer coating may be applied to the inorganic core, preferably only one coat of the outer coating is applied to the core.

Nevertheless, one or more additional coating layers may also be interposed between the outer coating and the inorganic core. The one or more additional coating layers may independently cover at least a part of the surface of the inorganic core.

The one or more additional coating layers may be otherwise defined as the outer coating herein.

The inorganic core may be solid up to at least 125° C., 150° C. or 175° C. The inorganic cores can therefore maintain their structural rigidity, and accordingly do not deform or melt onto the glass, when exposed to high glass surface temperatures. For example, when exposed to high glass surface temperatures associated with the manufacture of the glass sheets, in particular following cutting of the glass sheets or during storage in direct sunlight.

Typically, the biodegradable and/or water soluble polymer or film forming material leaves little or no residue on the glass surface, such as polymer residue.

The interleavant particle outer coating may be biodegradable. The one or more additional coating layers may be biodegradable.

The interleavant particles may be environmentally sustainable. The outer coating may be environmentally sustainable. The biodegradable and/or water soluble polymer or film forming material used in the outer coating may be environmentally sustainable. The one or more additional coating layers may be environmentally sustainable. The water soluble polymer or film forming material may also be biodegradable.

The Polymer or Film Forming Material and Outer Coating

Typically, the biodegradable and/or water soluble polymer or film forming material is a polymer or a rosin.

Suitably, the biodegradable and/or water soluble polymer or film forming material is selected from:—
a polyester such as a poly(lactic acid), a poly(butylene succinate), a poly(caprolactone) or a poly(hydroxyalkanoate) for example polyhydroxybutyrate,
a polyether such as a poly(ethylene glycol) or a poly(propylene glycol),
a poly (alk)acrylic acid such as a poly(acrylic acid) or a poly(methacrylic acid),
a polyamide such as a poly(amino acid) or a poly(caprolactam),
a poly(ester-amide) such as a co-polymer of a poly(ester) and an amino acid or a co-polymer of a poly(ester) and an amino acid and an imide,
a polyurethane such as a polyurethane formed from a poly(ester) polyol and an aliphatic diisocyanate,
a poly(vinyl alcohol),
a poly(vinyl acetate),
a poly(acrylate) such as a hydroxyl functional poly(acrylate) such as poly(hydroxyethylacrylate),
a poly(methacrylate) such as a hydroxyl functional poly(methacrylate) such as poly(hydroxyethylmethacrylate),
a poly(glycolic acid),
a poly(peptide) or poly(peptide) derivative such as lacto(peptides), casein, collagen, actin, and fibrin,
a poly(propylene fumarate),
a poly(phosphazene) such as poly[bis(trifluoroethoxyphosphazene],
a poly(phosphoester),
a poly(saccharide) or poly(saccharide) derivative such as chitin, keratin and chitosan,
poly(ethylene glycol).
a cellulose such as microfibrillated cellulose, rayon, cellophane, lignocellulose, natural biopolymers and derivatives such as suberin, melanin, lignin, cutin, cutan, starch and starch derivatives,
and a rosin such as gum rosin and derivatives such as a hydrogenated rosin or a metal rosinate.

The polyether may be a poly(ethylene glycol) such as Pluriol® E6000. The poly(alk)acrylic acid may be a polyacrylic acid such as Acusol™ 190K or Acumer™ 1510.

The term rosin herein includes gum rosin, wood rosin, oleorosin, abietic acids, sapinic acids, pimaric acids and the like and any other products that are generally termed colophony. The rosin may be a rosin derivative such as a suitable metal salt (for example zinc or copper), or a polymerized, hydrogenated, disproportionated, esterified or optionally substituted rosin derivative. The rosin derivative may be a partially or fully hydrogenated rosin (such as Staybelite-E™ or Foral AX-E™) or a dimeric rosin acid (such as Dymerex™ dimerised gum rosin). Such materials may be used as film forming material for the outer coating.

Advantageously, when used as the outer coating film forming material the rosin helps to promote adhesion of the glass interleavant particles to the glass sheets.

The term cellulose herein includes cellulose derivatives. A suitable cellulose material includes but is not limited to, a cellulose ether, a microfibrillated cellulose, a cellulose ester, an enzymatically treated cellulose or an optionally substituted cellulose. The cellulose ether may be a material such as methyl cellulose, ethyl cellulose, hydroxy ethyl cellulose, hydroxypropyl cellulose, hydroxypropyl methyl cellulose or carboxy methylcellulose. The hydroxy ethyl cellulose may be Natrosol™ 250 HEC. The microfibrillated cellulose may be Exilva® F01-V or Exilva® F01-L. Such materials may be used for the outer coating.

The biodegradable material may comprise a L(+)-lactic acid monomer residue and a D(−)-lactic acid monomer residue.

The polymer or film forming material may be in an amount of >0.025% based on the total weight of the interleavant particles, such as >0.05% or >0.125%.

The polymer or film forming material may be in an amount of ≤40% based on the total weight of the_interleavant particles, such as ≤20% or ≤10%.

The polymer or film forming material may be in an amount from 0.025-40% based on the total weight of the interleavant particles, typically from 0.05 to 30%, even more typically from 0.125 to 25%. The polymer or film forming material may be in an amount of at least 1, 2 or 5% based on the total weight of the interleavant particles.

The outer coating may be in an amount of ≥0.1% based on the total weight of the_interleavant particles, such as ≥0.2% or ≥0.5%.

The outer coating may be in an amount of ≤40% based on the total weight of the_interleavant particles, such as ≤20% or ≤10%.

The outer coating may be in an amount from 0.1-40% based on the total weight of the interleavant particles, typically from 0.2 to 30%, even more typically from 0.5 to 25%. The outer coating may be in an amount of at least 4, 8 or 20% based on the total weight of the interleavant particles.

The outer coating may have an uncompressed thickness of ≤50 μm, typically, <30, more typically, <20 μm.

The outer coating may have an uncompressed thickness of ≥0.1 μm, more typically, >0.2 μm, more typically, >0.5 μm.

The outer coating may have an uncompressed thickness of from 0.1 to 50 μm, more typically, 0.2 to 30 μm, most typically, 0.5 to 20 μm. ≥65% of the inorganic cores may be coated with the outer coating having such uncompressed thickness. ≥75% of the inorganic cores may be coated with the outer coating having such uncompressed thickness. ≥85% of the inorganic cores may be coated with the outer coating having such uncompressed thickness. ≥95% of the inorganic cores may be coated with the outer coating having such uncompressed thickness and, in each case, this may be any one of the uncompressed thickness limits or ranges above.

The uncompressed thickness may be determined by a subtraction method whereby the average particle size of the core particle is subtracted from the average particle size of the coated particle. Particle size in this context is determined by the light scattering techniques mentioned herein.

The adhesion of the coating to the core during application and/or use is not highly critical. Any coating material that is shed from the core will generally remain on the glass surface to which the interleavant is applied and still act to protect the glass surface from abrasion and staining. Advantageously, this is a convenient way to further protect the glass sheets. The cores may be overloaded with coating to provide a source of coating material which may be shed in use and provide a dusting to protect the surface of the glass. Accordingly, the interleavant particles may be effective to shed an average of between 1-99% of the coating in use, more typically, 5-90%, most typically, 10-80%.

When a rosin is utilized as the film forming material of the outer coating, the coating may have an uncompressed thickness of ≤30 μm. Typically, the coating may have an uncompressed thickness of ≥0.1 μm. Such a coating may have an uncompressed thickness of from 0.2-28 μm, typically, an uncompressed thickness of from 0.5-20 μm.

The water soluble polymer or film forming material may have a water solubility at pH 7 and 20° C. of ≥2 g/L.

The water soluble polymer or film forming material may have a water solubility at pH 7 and 20° C. of from 2-200 g/L, such as from 2-50 g/L.

The Mohs hardness in the Mohs hardness scale of the outer coating may be from 1 to 7, such as from 1 to 6, for example 1 to 5.

The Mohs hardness in the Mohs hardness scale of the biodegradable and/or water soluble polymer or film forming material may be from 1 to 7, such as from 1 to 6, for example 1 to 5.

Typically, the outer coating is of a Mohs hardness that does not scratch or abrade the surface of the glass sheets when in use.

The biodegradable and/or water soluble material when polymeric may comprise one or more further monomer residues.

The polymeric biodegradable and/or water soluble polymer may have a weight average molecular weight (Mw) of ≤750,000 Da. The biodegradable and/or water soluble may have a weight average molecular weight (Mw) of ≥2500 Da.

When polymeric, the biodegradable and/or water soluble material may be a block copolymer, an alternating copolymer, or a random copolymer. The biodegradable and/or water soluble material may be a linear polymer or branched polymer.

Molecular weight herein may be determined by GPC using appropriate standards.

The Particles

The interleavant particles or composition may have an average particle size as determined by light scattering of ≤400 μm.

The interleavant particles or composition may have an average particle size as determined by light scattering of ≥10 μm.

The interleavant particles or composition may have an average particle size as determined by light scattering of from 20-300 μm.

The interleavant particles or composition may have an average particle size as determined by light scattering of from 25-200 μm, typically, 50-150 μm.

In terms of particle size distribution, the interleavant particles or composition may have <10% v/v total particles >400 μm, typically, <1% v/v total particles >500 μm as determined by light scattering. The interleavant particles may have <10% v/v total particles <1 μm as determined by light scattering.

The average particle size as determined by light scattering, as described previously, may provide uniform spacing between sheets of glass. This in-turn optimizes the amount of interleavant particles used and thereby reduces wastage.

Providing interleavant particles with an average particle size as determined by light scattering may facilitate application of the interleavant particles to the surface of the glass.

The interleavant particles may be generally spherical or cylindrical in shape. Typically, the interleavant particles are generally spherical in shape. The interleavant particles may have a smooth or textured surface.

The interleavant particles herein may be broadly spherical. In any case, the particles will generally have an average aspect ratio of at least 0.5, such as at least 0.6, 0.7, 0.8, 0.9 or 0.95.

The core material is chosen to be capable of forming or being formed into generally spherical particles of the required size.

Glass and other inorganic glassy materials are particularly advantageous for this purpose being available in the form of microspheres or being subjectable to milling to form such microspheres.

The Core

The core has a compressive strength of at least 3 MPa such as at least 5 MPa, typically, at least 10, 50 or 70 MPa.

Compressive strength of the core may be taken by measuring the bulk material. Although designed for plastics a suitable technique may be based on the general principles of ASTM D695 (Standard Test Method for Compressive Properties of Rigid Plastics). The general approach for determining compressive strength is to apply a compressive load to a specimen of the material (in the form of cylinder) positioned between two compressive plates mounted in a universal testing machine. The specimen is placed between the compressive plates parallel to the surface and the specimen is then compressed at a uniform rate. The maximum load applied during the test is recorded and the compressive strength is calculated to be the maximum compressive load divided by the cross-sectional area of the specimen. The test should be carried out at 23° C. and a relative humidity of 50%.

The inorganic core may comprise one or more of glass, silica gel, ceramic or mineral materials or may be selected from a metal salt or metalloid compound. Suitably, the inorganic core may be selected from the group consisting of a metal carbonate (such as calcium carbonate), sulphate (such as calcium sulphate or barium sulphate), borate (such as calcium borate or sodium borate), oxide (such as zirconium dioxide, titanium dioxide or an iron oxide), nitride (such as silicon nitride), oxynitride (such as a sinoite or a perovskite), carbide (such as silicon carbide), titanate (such as calcium titanate) and chlorite (such as a phyllosilicate). Suitable metals or metalloids for the aforementioned compounds may be selected from calcium, sodium, titanium, zirconium, barium, iron, aluminium, magnesium, silicon or copper.

Typically, the inorganic core comprises one or more of glass, silica gel, or ceramic materials. Even more typically, the inorganic core comprises glass. The inorganic material is advantageously hard but exhibits poor adherence to glass. Advantageously, if the inorganic core is coated with an outer biodegradable and/or water soluble polymer or film forming material coating this prevents the inorganic core from scratching the glass sheets. In addition, the biodegradable and/or water soluble polymer or film forming material coating adheres successfully to the glass sheets.

In particular, glass beads, silica gel beads, ceramic beads or mineral beads may be used as the inorganic core. Suitable materials are also defined in the claims.

The inorganic core glass, silica gel, ceramic, metal salt or mineral materials may be present in an amount of ≥5% based on the total weight of the inorganic core, such as ≥25% or ≥50% or >75, 85, 95 or approximately 100%.

The inorganic core glass, silica gel, ceramic, metal salt or mineral materials may be present in an amount of ≤100% based on the total weight of the inorganic core, such as ≤99% or ≤95%.

The inorganic core glass, silica gel, ceramic, metal salt or mineral materials may be present in an amount of from 5 to 100% based on the total weight of the inorganic core, such as from 20 to 100% or from 40 to 100% or from 90-100%. Typically, the inorganic core glass, silica gel, ceramic or mineral materials may be present in an amount of from 5 to 100% based on the total weight of the inorganic core.

The inorganic core may have an average particle size as determined by light scattering of ≤400 μm.

The inorganic cores may have an average particle size as determined by light scattering of ≥10 μm.

The inorganic cores may have an average particle size as determined by light scattering of from 10-199 μm, typically 30-149 μm.

The inorganic core may be in an amount of ≥50% based on the total weight_of the interleavant particles, such as ≥55%, ≥70% or ≥75%.

The inorganic core may be in an amount of ≤99.9% based on the total weight_of the interleavant particles, such as ≤99.8%, ≤99.5% or ≤99%.

The inorganic core may be in amount from 50-99.9% based on the total weight of the interleavant particles, typically from 60 to 99.8%, even more typically from 70 to 99.5%, even more typically from 75 to 99%. The inorganic core may be in an amount of 75% based on the total weight of the interleavant particles.

In some embodiments of the interleavant particles of the invention or interleavant particle composition, the polymer or film forming material is a rosin and the inorganic core is calcium carbonate.

In some embodiments of the interleavant particles of the invention or interleavant particle composition, the coating is a powder coating.

Tg

The inorganic core particles may have a glass transition temperature (Tg) greater than 150° C. measured using differential scanning calorimetry (DSC) or thermomechanical analysis (TMA), such as greater than 200° C. Advantageously, such allows for good compressive strength to be retained under operating temperatures.

The outer coating material may have a glass transition temperature (Tg) or softening point from 50 to 200° C. measured using well known techniques such as differential scanning calorimeter (DSC), thermomechanical analysis (TMA) or Ring and Ball (ASTM E28), such as from 60 to 150° C. Advantageously, such a coating allows for good flow of the particles under application temperatures.

Interleavant particles having the above Tg values maintain their structural rigidity, and accordingly do not melt onto the glass, when exposed to high glass surface temperatures. For example, when exposed to high glass surface temperatures associated with the manufacture of the glass sheets, in particular following cutting of the glass sheets.

Inorganic cores and/or outer coatings having the above Tg values maintain their structural rigidity, and accordingly do not deform or melt onto the glass, when exposed to high glass surface temperatures.

Additives

The biodegradable and/or water soluble polymer or film forming outer coating may further comprise an additive selected from one or more of an acid functional modifier, film forming agents, diluents, particulate fillers, processing aids, lubricant, plasticizer, agents for increasing the melt strength, agents for increasing abrasion resistance, hydrophobizing agents or coupling agents. The additives may be biodegradable.

The additive may be one or more of graphite, talc or gum rosin with the proviso that if the additive is gum rosin the material of the outer coating is not gum rosin, more typically, not rosin.

The acid functional modifier advantageously prevents or mitigates staining of the glass sheets. The acid functional modifier may also modify viscosity of the outer coating.

Generally, the outer coating may comprise one or more additives in an amount of ≥1% based on the total weight of the outer coating, such as ≥5%, ≥10% or ≥15%.

The outer coating may comprise one or more additives in an amount of ≤40% based on the total weight of the outer coating, such as ≤35%, ≤30% or ≤20%.

The outer coating may comprise one or more additives in an amount of from 1 to 40% based on the total weight of the outer coating, such as from 5 to 35%, 10 to 30% or from 15 to 20%. %

The balance of the outer coating in each of the above % by weight of additive is in each case made of the biodegradable or water soluble polymer or film forming material.

Although the acid functional modifier may be added to the outer coat, it is more usually mixed with the interleavant particles, for example it may be dry blended with the particles.

According to another aspect of the present invention there is provided a composition comprising the interleavant particles as defined herein. Typically, the composition may also include acid functional modifiers as defined herein.

Typically, the acid functional modifier is selected from one or more of adipic acid, boric acid, maleic acid, succinic acid, malic acid, benzoic acid, sebacic acid, gum rosin (with the proviso that this is not the same material as the biodegradable or water soluble polymer or film forming material), a gum rosin derivative or a polyacrylic acid, typically, the acid functional modifier is adipic acid, boric acid or maleic acid.

The amount of the acid functional modifier is from 1-75% based on the total weight of the composition, typically from 5-60%.

When the biodegradable and/or water soluble polymer or film forming material is a polymer and is blended with the rosin to form a polymer/rosin blend, the rosin may act as an acid functional modifier and makes the blend less viscous and thereby easy to handle. Accordingly, rosin can also be added to the interleavant particles in the composition as an acid functional modifier.

The outer coating may further comprise one or more additive polymers to further modify the properties of the biodegradable or water soluble polymer or film forming material.

The biodegradable and/or water soluble polymer and the one or more additive polymers may form a polymer blend.

The glass sheets of any of these aspects may be flat or curved glass.

Glass sheets referred to herein are known to the skilled person in the art of glass sheet production and transport where interleavants are required. However, for the avoidance of doubt, such sheets would typically cover an area of at least 0.5 m², more typically such sheets are much larger without limit of size and determined only by transport and manufacturing limitations such as up to 30, 50 or 100 m²

Methodology

The outer coating may be combined with the inorganic core by melt processing of the inorganic core particles and outer coating material in an extruder or other melt processing apparatus. Alternatively, slurry casting techniques can be used whereby the outer coating material is dispersed or dissolved in a solvent, mixed with inorganic core particles to form a slurry and then the solvent is removed by a drying process such as spray drying, oven drying, vacuum drying, filter drying, fluidised bed drying or pan drying to produce the combination of inorganic core particles and outer coating material. Alternatively, an aqueous dispersion of outer coating material may be mixed with the inorganic core and the coating may be applied to the core by coagulation or precipitation techniques followed by a suitable drying process. Alternatively, water may be added to a blend of the inorganic core particles and the outer coating material to dissolve or partially dissolve the outer coating and deposit it on the outer surface of the core. The material may then be dried as per one of the drying processes described above.

The core particles may be prepared by ultrasonic spray pyrolysis.

Alternatively, the core particles may be prepared by milling

The outer coating may be applied to the core by any suitable method, for example melt processing or coagulation/precipitation.

The interleavant particles or compositions may be applied to the glass sheets by any suitable technique. Typically, the interleavant particles or composition are disposed onto the surface of the glass sheet by spreading, typically, by randomly spreading, an amount of about 100-8000 mg/m² of glass sheet, typically about 200-6000 mg/m².

### Definitions

As used herein, unless otherwise expressly specified, all numbers such as those expressing values, ranges, amounts or percentages may be read as if prefaced by the word “about”, even if the term does not expressly appear. The term “about” when used herein means+/−10% of the stated value. Also, any numerical range recited herein is intended to include all sub-ranges subsumed therein. Singular encompasses plural and vice versa. For example, although reference is made herein to “an” alcohol, “a” compound according to formula (I), “a” rheology modifier, and the like, one or more of each of these and any other components can be used. As used herein, the term “polymer” refers to oligomers and both homopolymers and copolymers, and the prefix “poly” refers to two or more. Including, for example and like terms means including for example but not limited to. Additionally, although the present invention has been described in terms of “comprising”, the processes, products, and compositions detailed herein may also be described as “consisting essentially of” or “consisting of”.

By glass herein is meant a silicate, preferably a borosilicate, an aluminosilicate, a soda-lime silicate or a soda-lime-borosilicate. Typically, the glass herein, particularly in relation to the glass sheets is not fused silica or quartz glass.

By silica gel herein is meant a silicate with a porous surface structure.

Light scattering herein may be determined by a Coulter LS230 laser diffraction instrument.

By “free from” herein is meant <1% w/w, more typically, <0.1% w/w.

The term density means the volumetric mass density at 25° C. unless indicated otherwise.

Where ranges are provided in relation to a genus, each range may also apply additionally and independently to any one or more of the listed species of that genus. All of the features contained herein may be combined with any of the above aspects in any combination.

For a better understanding of the invention, and to show how embodiments of the same may be carried into effect, reference will now be made, by way of example, to the following experimental data.

### EXAMPLES

### Example 1

Glass Microspheres (mean diameter 55 μm measured by light scattering, 99 g) and powdered hydrogenated rosin (Foral AX-E™, 1 g) were combined and dry blended for 15 min. The powder was heated to 175° C. for 2 h to melt the hydrogenated rosin. The mixture was stirred and returned back to the oven at 175° C. for a further 1 h. Further cycles of oven treatment (175° C.) and agitation were employed to homogenise the sample. The mixture was cooled to room temperature and sieved through a 200 μm mesh to yield the final composite. A thin coating of the glass microspheres with hydrogenated rosin is observed by microscopic inspection of the particles. This is observable as a translucent film that coats the outside of the clear glass microspheres.

### Example 2

Glass Microspheres (mean diameter 55 μm measured by light scattering, 49 g), polyacrylic acid (Acusol™ 190K, 25% w/w aqueous solution, 2 g) were mixed for 15 mins. An alcohol ethoxylate surfactant (Neodol® LE, 10% w/w aqueous solution, 1 g) was added to enable the aqueous polyacrylic acid solution to fully wet out the glass microspheres. The mixture was dried using a fluidised bed drier (50° C.) and loose agglomerates broken up to yield a free flowing powder. The mixture was cooled to room temperature and sieved through a 200 μm mesh to yield the final composite. A thin partial coating of the glass microspheres with polyacrylic acid is observed by microscopic inspection of the particles.

### Example 3

Glass Microspheres (mean diameter 99 μm measured by light scattering, 83 g) and poly(butylene succinate) pellets (BioPBS™ FZ91PB available from MCPP, 17 g) were added to an aluminium dish and heated in an oven at 175° C. for 2 h to melt the BioPBS pellets. The mixture is then stirred and returned back to an oven at 175° C. for a further 1 h. The mixture is stirred again and allowed to cool to room temperature. The BioPBS-glass particulate mass is broken down by agitation using a 2-blade blender such that individual particles of BioPBS-glass particulate are obtained. The broken down mixture is then further homogenised by being placed in an oven at 175° C. for 1 h. Further cycles of oven treatment (175° C.) and agitation (2-blade blender) are employed to homogenise the sample further and yield the final composite (mean diameter 137 μm measured by light scattering). The coating of the glass microspheres with BioPBS polymer is observed by microscopic inspection of the particles. An average coating thickness of 19 μm is inferred from light scattering measurements of the diameter of the glass microsphere core and the coated product.

Samples from Examples 1-3 were assessed for adhesion to glass by application of a measured quantity of material to cover the surface of a 30×30 cm glass. The glass adhesion was quantified by elevating the glass sheet to a 90° angle and collecting any non-adhering material. The % retention (i.e. glass adhesion) was quantified for each sample. For comparison, glass adhesion data for a commercially available microplastic PMMA interleavant powder (Colacryl® TS2050, available from Mitsubishi Chemical UK Specialty Polymer and Resins Ltd) and uncoated glass microspheres (55 μm measured by light scattering) were also collected. Table 1 indicates the enhanced glass adhesion performance associated with samples 1 and 2.

TABLE 1
Glass adhesion data for samples produces as per Examples 1 and 2.

| Interleaving Powder | Glass Adhesion |
|---|---|
| Sample 1 (Example 1) | 95.9% |
| Sample 2 (Example 2) | 84.5% |
| PMMA (Colacryl ®TS2050) | 89.6% |
| Glass microspheres (55 μm) | 82.6% |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. Interleavant particles for location between adjacent stacked glass sheets, the interleavant particles comprising an inorganic core with an outer coating, the outer coating being formed of a biodegradable and/or water soluble polymer or film forming material, wherein the inorganic core is solid up to at least 100° C., has a compressive strength of at least 3 MPa and has a volumetric mass density less than 7.5 g/cm³ at 25° C.

2. The interleavant particles according to claim 1, wherein the polymer or film forming material is selected from a polymer or a rosin.

3. The interleavant particles according to claim 1, wherein the polymer or film forming material is selected from:—
a polyester such as a poly(lactic acid), a poly(butylene succinate),
a poly(caprolactone) or a poly(hydroxyalkanoate) for example polyhydroxybutyrate,
a polyether such as a poly(ethylene glycol) or a poly(propylene glycol),
a poly (alk)acrylic acid such as a poly(acrylic acid) or a poly(methacrylic acid),
a polyamide such as a poly(amino acid) or a poly(caprolactam),
a poly(ester-amide) such as a co-polymer of a poly(ester) and an amino acid or a co-polymer of a poly(ester) and an amino acid and an imide,
a polyurethane such as a polyurethane formed from a poly(ester) polyol and an aliphatic diisocyanate,
a poly(vinyl alcohol),
a poly(vinyl acetate),
a poly(acrylate) such as a hydroxyl functional poly(acrylate) such as poly(hydroxyethylacrylate),
a poly(methacrylate) such as a hydroxyl functional poly(methacrylate) such as poly(hydroxyethylmethacrylate),
a poly(glycolic acid),
a poly(peptide) or poly(peptide) derivative such as lacto(peptides), casein, collagen, actin, and fibrin,
a poly(propylene fumarate),
a poly(phosphazene) such as poly[bis(trifluoroethoxyphosphazene],
a poly(phosphoester),
a poly(saccharide) or poly(saccharide) derivative such as chitin, keratin and chitosan,
poly(ethylene glycol),
a cellulose such as microfibrillated cellulose, rayon, cellophane, lignocellulose, natural biopolymers and derivatives such as suberin, melanin, lignin, cutin, cutan, starch and starch derivatives, and
a rosin such as gum rosin and derivatives such as a hydrogenated rosin or a metal rosinate.

4. The interleavant particles according to claim 1, wherein the polymer or film forming material is selected from polylactic acid, poly butylenesuccinate, polyhydroxybutyrate, polyacrylic acid, a rosin or a cellulose.

5. The interleavant particles according to claim 4, wherein the polymer or film forming material of the outer coating is a rosin or a cellulose.

6. The interleavant particles according to claim 5, wherein the polymer or film forming material of the outer coating is a rosin.

7. The interleavant particles according to claim 1, wherein the polymer or film forming material is a rosin and wherein the inorganic core is calcium carbonate.

8. The interleavant particles or interleavant particle composition according to claim 1, wherein the coating is a powder coating.

9. The interleavant particles according to claim 1, wherein the amount of the polymer or film forming material is from 25-100% based on the total weight of the outer coating.

10. The interleavant particles according to claim 1, wherein the interleavant particles have an average particle size as determined by light scattering of ≤400 μm.

11. (canceled)

12. The interleavant particles according to claim 1, wherein the inorganic core has an average particle size as determined by light scattering of ≤400 μm.

13. (canceled)

14. The interleavant particles according to claim 1, wherein the outer coating has an average uncompressed thickness of 0.1-50 μm.

15. The interleavant particles according to claim 1, wherein polymer has a weight average molecular weight (Mw) in the range of 2,500 to 750,000 Da.

16. The interleavant particles according to claim 1, wherein the water soluble material has a water solubility at pH 7 and 20° C. of ≥0.2 g/l.

17. The interleavant particles according to claim 1, wherein the hardness in the Mohs hardness scale of the outer coating is <7.

18. The interleavant particles according to claim 1, wherein the Mohs hardness in the Mohs hardness scale of the inorganic core is from 3-8.

19. The interleavant particles according to claim 1, wherein the inorganic core has a glass transition temperature (Tg) greater than 150° C. measured using differential scanning calorimetry (DSC) or thermomechanical analysis (TMA), such as greater than 200° C.

20. The interleavant particles according to claim 1, wherein the outer coating has a glass transition temperature (Tg) or softening point from 50 to 200° C. measured using well known techniques such as differential scanning calorimeter (DSC), thermomechanical analysis (TMA) or Ring and Ball (ASTM E28), such as from 60 to 150° C.

21. The interleavant particles according to claim 1, wherein the polymer or film forming material is other than rosin and is blended with the rosin to form a polymer/rosin blend.

22. The interleavant particles according to claim 21, wherein the rosin is in an amount of from 0.1 to 8%.

23. The interleavant particles according to claim 1, wherein the inorganic core is a glass, silica gel, ceramic, metal salt, metalloid compound or mineral material, typically, a silica gel or glass core, typically, a glass core.

24-28. (canceled)

29. The interleavant particles according to claim 1, wherein the inorganic core is from 50-99.9% w/w interleavant particles.

30. The interleavant particles according to claim 1, wherein the amount of the outer coating is from 0.1-40% w/w interleavant particles.

31. The interleavant particles according to claim 1, wherein the outer coating includes an additive.

32. The interleavant particles according to claim 31, wherein the additive is selected from one or more of an acid functional modifier, film forming agents, diluents, particulate fillers, processing aids, lubricant, plasticizer, agents for increasing the melt strength, agents for increasing abrasion resistance, hydrophobizing agents and coupling agents.

33. The interleavant particles according to claim 1, wherein the outer coating is in contact with the inorganic core i.e. without an intermediate layer.

34. (canceled)

35. (canceled)

36. The interleavant particles according to claim 1 wherein the outer coating is a biodegradable material.

37. The interleavant particles according to claim 1, wherein the outer coating is a water soluble material.

38. The interleavant particles according to claim 1, wherein the outer coating is a polymer.

39. (canceled)

40. The interleavant particles according to claim 1 wherein the outer coating is a film.

41. (canceled)

42. A composition for use as a glass interleavant comprising interleavant particles according to claim 1.

43. The composition for use as an interleavant according to claim 42, further comprising an acid functional modifier.

44. The composition for use as an interleavant according to claim 42, further comprising a flow modifier to improve flow of the particles.

45. The composition for use as an interleavant according to claim 42, wherein the acid functional modifier is dry blended with the particles.

46. The interleavant particles according to claim 1 or a composition for use as an interleavant according to claim 42, wherein the acid functional modifier is selected from one or more of adipic acid, boric acid, maleic acid, succinic acid, malic acid, benzoic acid, sebacic acid, gum rosin (with the proviso that this is not the same material as the biodegradable or water soluble polymer or film forming material), a gum rosin derivative or a polyacrylic acid, typically, the acid functional modifier is adipic acid, boric acid or maleic acid.

47. A composition for use as an interleavant according to claim 42, wherein the amount of the acid functional modifier is from 1-75% based on the total weight of the composition.

48. A method of providing a stack of spaced glass sheets, the method comprising:
(i) providing interleavant particles or a composition according to claim 1;
(ii) applying the interleavant particles or composition onto a first surface of a glass sheet; and
(iii) laying a further glass sheet over the said first surface of the glass sheet.

49. The method according to claim 48, wherein the stack of spaced glass sheets comprises three or more glass sheets, suitably by repeating the steps of (ii) and (iii) in relation to each succeeding glass sheet.

50. The method according to claim 48, wherein the glass sheets are float glass, annealed glass, toughened glass, soft coated glass, hard coated glass or laminated glass.

51. The method according to claim 48, wherein the interleavant particles or composition are disposed onto the surface of the glass sheet by spreading, typically, by randomly spreading, an amount of at least 25 mg/m² of glass sheet.

52. The method according to claim 51, wherein the particles or interleavant composition are applied to the glass sheets by an applicator which charges the interleavant particles as they are sprayed on to the glass sheets with sufficient electrostatic charge.

53. The method according to claim 48, wherein the thickness of the glass is from 1 to 30 mm.

54.-56. (canceled)

57. A stack of glass sheets, wherein the glass sheets are spaced apart by interleavant particles or a composition according to claim 1.

58. The stack of glass sheets according to claim 57, wherein the glass sheets are float glass, annealed glass, toughened glass, soft coated glass, hard coated glass or laminated glass.

59. The stack of glass sheets according to claim 57, wherein the thickness of the glass is from 1 to 30 mm.
